(19) United States
(12) Patent Application Publication
(10) Pub. No.: US 2023/0215192 A1
(43) Pub. Date: Jul. 6, 2023

(54) VEHICLE FOR IDENTIFYING SEATING OF PASSENGER AND OPERATING METHOD THEREOF

(71) Applicants: Hyundai Motor Company, Seoul (KR); Kia Corporation, Seoul (KR)

(72) Inventors: Yim Ju Kang, Seoul (KR); Young Il Na, Hwaseong (KR); Hoon Lee, Gunpo (KR); Jae Nam Yoo, Incheon (KR); Chang Jae Lee, Yongin (KR); Wan Jae Lee, Suwon (KR)

(21) Appl. No.: 17/969,073

(22) Filed: Oct. 19, 2022

(30) Foreign Application Priority Data
Dec. 30, 2021 (KR) 10-2021-0193235

(51) Int. Cl. G06V 20/59; G06V 40/10; G06V 40/16; G06V 40/18; G06T 7/70; B60Q 9/00

(52) U.S. Cl. CPC G06V 20/593; G06V 40/103; G06V 40/172; G06V 40/18; G06T 7/70; B60Q 9/00; G06T 2207/30201; G06T 2207/30268; B60Q 2800/10; B60Q 2800/30

(57) ABSTRACT

A vehicle includes a first sensor for sensing a first image, a second sensor for sensing a second image, and a processor that is configured to generate seating information of a passenger based on the first image, and generate posture information of the passenger with the generated seating information based on at least one of the first image or the second image.

### CROSS-REFERENCE TO RELATED APPLICATION

This application claims under 35 U.S.C. § 119(a) the benefit of Korean Patent Application No. 10-2021-0193235, filed in the Korean Intellectual Property Office on Dec. 30, 2021, the entire contents of which are incorporated herein by reference.

### TECHNICAL FIELD

Embodiments of the present disclosure relate to an autonomous vehicle that identifies seating and a posture of a passenger and an operating method thereof.

### BACKGROUND

An autonomous vehicle is required to determine whether it is possible to depart or travel by itself, as a driver does not board.

In particular, the autonomous vehicle must determine whether it is possible to depart or travel by determining whether a passenger is seated and determining a posture of the seated passenger by itself. When the vehicle departs without the passenger being seated or when the passenger is seated in an unsafe posture, there is a risk of an accident.

### SUMMARY

The present disclosure has been made to solve the above-mentioned problems occurring in the prior art while advantages achieved by the prior art are maintained intact.

An aspect of the present disclosure provides a vehicle capable of generating seating information and posture information of passengers based on images collected through a sensor.

Another aspect of the present disclosure provides a vehicle determining whether departure or travel is possible based on seating information and posture information of passengers, thereby securing safety of the passengers when the vehicle departs.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle includes a first sensor for sensing a first image, a second sensor for sensing a second image, and a processor that generates seating information of a passenger based on the first image, and generates posture information of the passenger with the generated seating information based on at least one of the first image or the second image.

In one embodiment, the processor may generate information of a seat in the vehicle and position information of the passenger based on the first image, and generate the seating information when the seat information matches the position information of the passenger.

In one embodiment, the processor may transmit a seating notification signal to the passenger when the position information of the passenger does not match the seat information.

In one embodiment, the first image may be an image captured in a direction perpendicular to a ground.

In one embodiment, the posture information may include information about at least one of a gaze of the passenger or a seating posture of the passenger.

In one embodiment, the processor may assign a degree of risk corresponding to at least one of the gaze of the passenger or the seating posture of the passenger, and transmit a posture notification signal to the passenger based on the degree of risk.

In one embodiment, the processor may match the first image or the second image with the posture information and store the matched information.

In one embodiment, the processor may match and store the first image or the second image with the degree of risk, or match and store the posture information with the degree of risk.

In one embodiment, the second image may be an image captured in a direction horizontal to a ground, so that the passenger's face is included.

In one embodiment, the processor may match a passenger contained in the first image with a passenger contained in the second image.

In one embodiment, the processor may generate a departure possible signal or a travel possible signal when seating information of all passengers in the vehicle are generated based on the seating information and the posture information, and postures of all of the passengers are safe.

In one embodiment, the processor may sense the first image or the second image when the vehicle is stopped.

In one embodiment, the vehicle may further include a notification device for spreading a posture notification signal or a seating notification signal.

According to another aspect of the present disclosure, an operating method of a vehicle includes sensing a first image through a first sensor, generating, by a processor, seating information of a passenger based on the first image, sensing a second image through a second sensor, and generating, by the processor, posture information of the passenger with the generated seating information based on at least one of the first image or the second image.

In one embodiment, the method may further include generating, by the processor, information of a seat in the vehicle based on the first image, and generating, by the processor, position information of the passenger based on the first image, and the processor may generate the seating information when the seat information matches the position information of the passenger.

In one embodiment, the method may further include transmitting, by the processor, a seating notification signal to the passenger when the position information of the passenger does not match the seat information.

In one embodiment, the method may further include determining, by the processor, whether a posture of the passenger is safe based on the posture information, and transmitting, by the processor, a posture notification signal to the passenger when the posture of the passenger is not safe.

In one embodiment, the determining of whether the posture of the passenger is safe may include assigning, by the processor, a degree of risk corresponding to at least one of a gaze of the passenger or a seating posture of the passenger contained in the posture information, and determining whether the posture of the passenger is safe based on the degree of risk.

In one embodiment, the method may further include matching, by the processor, the first image or the second image with the posture information and storing the matched information, and matching and storing, by the processor, the first image or the second image with the degree of risk, or the posture information with the degree of risk.

In one embodiment, the method may further include generating, by the processor, a departure possible signal or a travel possible signal when seating information of all passengers in the vehicle are generated based on the seating information and the posture information, and postures of all of the passengers are safe.

As discussed, the method and system suitably include use of a controller or processer.

In another embodiment, vehicles are provided that comprise an apparatus as disclosed herein.

In a fully autonomous vehicle or system, the vehicle may perform all driving tasks under all conditions and little or no driving assistance is required from a human driver. In semi-autonomous vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks.

In certain embodiments, the present systems and vehicles may be fully autonomous. In other certain embodiments, the present systems and vehicles may be semi-autonomous.

### BRIEF DESCRIPTION OF THE DRAWINGS

The above and other objects, features and advantages of the present disclosure will be more apparent from the following detailed description taken in conjunction with the accompanying drawings:

FIG. 1 is a table in which automation levels of an autonomous vehicle are defined;

FIG. 2 is a block diagram for illustrating a vehicle that identifies passenger seating according to an embodiment of the present disclosure;

FIG. 3 is a first image according to an embodiment of the present disclosure;

FIG. 4 exemplarily shows a first image and a second image according to another embodiment of the present disclosure;

FIG. 5 is for illustrating an operating method of a vehicle that identifies passenger seating according to an embodiment of the present disclosure; and

FIG. 6 is a block diagram illustrating a computing system that identifies passenger seating according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

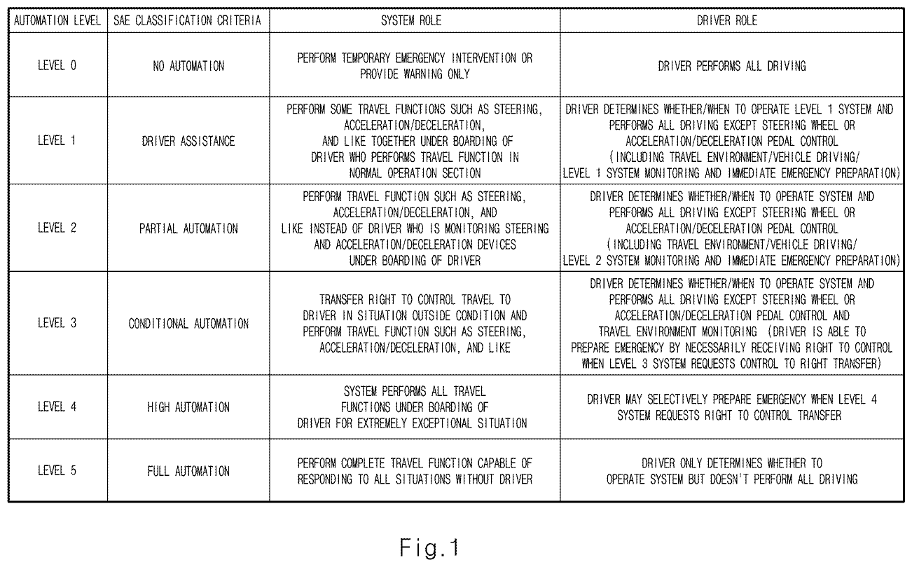

FIG. 1 is a table in which automation levels of an autonomous vehicle are defined.

The autonomous vehicle refers to a vehicle that recognizes a travel environment by itself to determine a risk, minimizes travel manipulation of a driver while controlling a travel route, and drives by itself.

Ultimately, the autonomous vehicle refers to a vehicle capable of traveling, controlling, and parking without an influence of humans, and is focused on a vehicle in a state in which an autonomous driving technology, which is a core foundation of the autonomous vehicle, that is, an ability to operate the vehicle without active control or monitoring of the driver is the most advanced.

Referring to FIG. 1, in automation levels 0 to 2, the travel environment is monitored by the driver. On the other hand, in automation levels 3 to 5, the travel environment is monitored by an automated driving system.

However, a concept of the autonomous vehicle currently being released may include an automation step of an intermediate step to the autonomous vehicle in a full sense, and corresponds to a goal-oriented concept on the premise of mass production and commercialization of a fully autonomous vehicle.

An autonomous driving control method according to the present disclosure may be applied to autonomous vehicles corresponding to a level 2 (partial automation) and a level 3 (conditional automation) among the automation levels of the autonomous driving shown in FIG. 1, but may not be necessarily limited thereto, and may be applied to autonomous vehicles that support a plurality of various automation levels.

The automation level of the autonomous vehicle based on the society of automotive engineers (SAE), which is an American association of automotive Engineers, may be classified as shown in the table in FIG. 1.

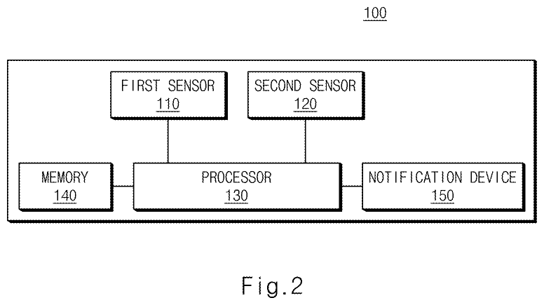

FIG. 2 is a block diagram for illustrating a vehicle that identifies passenger seating according to an embodiment of the present disclosure.

A vehicle 100 for identifying passenger seating may include a first sensor 110, a second sensor 120, a processor 130, and a memory 140. The vehicle 100 may be an autonomous vehicle corresponding to a level 4 or a level 5 in FIG. 1.

In a case of a vehicle where the driver has boarded, the driver may identify boarding of the passenger, and determine whether each passenger is seated and identify a posture of each passenger to determine whether departure or travel is possible. However, in a case of the autonomous vehicle 100, it may be difficult to determine whether the passenger is seated and identify the posture of the passenger. When the vehicle departs or travels regardless of whether the passenger is seated and the posture of the passenger, safety of the passenger may not be secured.

The first sensor 110 may be a sensor for sensing a first image. The first image may include an image corresponding to the passenger. The image corresponding to the passenger may include, for example, an image of the passenger boarded the vehicle 100.

The first sensor 110 may include an image sensor, and the image sensor may include, for example, a camera, an infrared camera, a thermal imaging camera, or the like.

An optical axis of the camera included in the first sensor 110 may be perpendicular to the ground. Therefore, the first image collected by the first sensor 110 may include an image that captures the passengers in the vehicle 100 in a direction perpendicular to the ground. Exemplarily, the first image may include an image of top surfaces of the passengers.

According to one embodiment, the first sensor 110 may be located on a ceiling of the vehicle 100. The processor 130 may classify the plurality of passengers based on the first image, and the first sensor 110 may be disposed at a position where it is easy to sense the image of the plurality of passengers such that a position of each passenger may be identified.

In addition, the first image may include an image of seats in the vehicle 100. The processor 130 may extract seat information corresponding to positions of the seats in the vehicle 100 based on the image of the seats, and extract position information corresponding to positions of the passengers in the vehicle 100 based on the image of the passengers.

According to an embodiment, the first image may include posture information of the passengers. The processor 130 may extract the posture information of the passenger viewed from the top based on the first image.

According to one embodiment, the first image may be sensed when the vehicle 100 is stopped. Whether the vehicle 100 is stopped may be determined by the processor 130.

For example, the processor 130 may determine whether the vehicle 100 is stopped based on a speed of the vehicle 100, a brake operation state, a gear state, and the like.

According to another embodiment, the first image may be sensed when the vehicle 100 is traveling, and the processor 130 may determine whether to continue the travel of the vehicle 100 by extracting seating information of the passenger during the travel.

An optical axis of a camera included in the second sensor 120 may be horizontal to the ground. Accordingly, a second image collected by the second sensor 120 may include an image that captures the passengers in the vehicle 100 in the direction horizontal to the ground. As an example, the second image may include an image of side surfaces of the passengers.

In addition, according to an embodiment, the optical axis of the camera included in the second sensor 120 may be located at a position the most horizontal to the ground among positions where the second image may contain information about a gaze of the passenger.

The second sensor 120 may include, for example, at least one of a stereo camera, a 3D LIDAR, a monocular camera, or the thermal imaging camera.

According to one embodiment, the second sensor 120 may be located at a rear portion of the vehicle 100 and at a center of the vehicle. Alternatively, the second sensor 120 may be installed for each seat. As an example, the second sensor 120 may be installed at a position where gaze directions of all of the passengers in the vehicle 100 may be identified.

The plurality of second sensors 120 may be installed, and may be arranged to identify the postures of the plurality of passengers.

The processor 130 may extract the posture information of the passengers in the vehicle 100 based on at least one of the first image or the second image. The posture information may include information corresponding to the posture of each passenger. For example, the posture information may include information about the gaze of the passengers, and may include information about a seating posture of each passenger.

According to one embodiment, the second image may be sensed when the vehicle 100 is stopped. Whether the vehicle 100 is stopped may be determined by the processor 130.

The processor 130 may determine whether the vehicle 100 is stopped based on the speed of the vehicle 100, the brake operation state, the gear state, and the like.

According to another embodiment, the second image may be sensed when the vehicle 100 is traveling, and the processor 130 may determine whether to continue the travel of the vehicle 100 by extracting the posture information of the passenger while traveling.

The processor 130 may receive the first image or the second image from the first sensor 110 and the second sensor 120.

The processor 130 may generate the seat information and the position information of the passenger based on the first image. The processor 130 may determine whether the position of the passenger in the vehicle 100 (the position information) matches the position of the seat in the vehicle 100 (the seat information). When the position information of the passenger matches the seat information, the processor 130 may determine that the passenger is seated. The processor 130 may generate seating information for the seated passenger.

When the position information of the passenger does not match the seat information, the processor 130 may determine that the passenger is not seated and transmit a seating notification signal to the passenger.

The processor 130 may determine whether the passengers are seated safely through the posture information generated based on at least one of the first image or the second image. For example, when the passengers are kneeling in the seat or the gaze thereof is directed to the rear of the vehicle, the processor 130 may determine that the corresponding passengers are not seated safely.

The processor 130 may transmit a posture notification signal to the passenger when the posture of the passenger is not safe. The posture notification signal may contain a content instructing the passenger to change the posture and guide information about a safe posture.

In addition, the processor 130 may contain a seat number of the passenger who needs to change the posture in the guide information when transmitting the posture notification signal. The seat number may be calculated based on the seat information.

In the case of the autonomous vehicle 100, a person monitoring the driver or the passenger does not board, so that the vehicle 100 may be operated even when the passenger is not seated or the seating posture is poor. When the vehicle 100 is operated in the state in which the passenger is not seated or the seating posture is poor, a safety accident may occur.

The processor 130 may generate a departure possible signal or a travel possible signal when the seating information of all of the passengers boarded the vehicle 100 are generated, and all of the passengers maintain the safe posture. When the processor 130 generates the departure possible signal or the travel possible signal, the vehicle 100 may start traveling. As an example, the safe posture may be a state in which the passengers lean their backs on backrests of the seats, look in a travel direction of the vehicle 100, and stretch their legs.

The processor 130 may assign degrees of risk to the postures of the passengers based on the posture information of the passengers. As an example, the processor 130 may assign different degrees of risk to the gaze of the passenger, a waist angle of the passenger, a leg angle of the passenger, and the like, and may transmit the posture notification signal to the passenger based on the degree of risk.

The posture information may, for example, contain information about a distance between body parts of the passenger and an angle between the body parts of the passenger contained in the image.

According to one embodiment, the processor 130 may detect the same passenger among the passengers in the first image and the passengers in the second image, and match the passengers.

In addition, the processor 130 may make the image of the passenger contained in the first image to correspond to the posture information generated based on the second image, and store the corresponded information in the memory 140.

The processor 130 may learn the posture of the passenger corresponding to the first image or the second image based on the first image or the second image stored by in correspondence with the posture information, and infer the posture of the passenger based on a newly collected image.

The processor 130 may detect images with high similarity by comparing the previously collected images with the newly collected image, and infer the posture information of the passenger from the newly collected image based on the posture information corresponding to the previously collected images.

The processor 130 may generate the posture notification signal without a separate posture information generation process by inferring the posture information of the passenger from the image, and transmit the posture notification signal to the passenger.

In addition, the processor 130 may make the degree of risk assigned based on the posture information to correspond to the image of the passenger included in the first image or the second image, and store the image in the memory 140. The processor 130 may learn the degree of risk of the passenger posture corresponding to the first image or the second image based on the first image or the second image stored in correspondence with the degree of risk, and infer a degree of risk from the newly collected image.

The processor 130 may detect the images with the high similarity by comparing the previously collected images with the newly collected image, and infer a degree of risk corresponding to a passenger of the newly collected image based on the degree of risk corresponding to the previously collected images.

According to one embodiment, the processor 130 may generate the departure possible signal or the travel possible signal based on the seating information of all of the passengers boarded the vehicle 100. Based on the departure possible signal, the processor 130 may switch a mode of the vehicle 100 from a stop mode to a travel mode.

The vehicle 100 may further include the memory 140, and the memory 140 may store the seat information, the position information of the passenger, the posture information of the passenger, and the like. In addition, objects contained in the first image and the second image may be matched with each other and stored in the memory 140. In addition, the memory 140 may match and store the posture information and the degree of risk.

The vehicle 100 may further include a notification device 150 for spreading the posture notification signal or the seating notification signal to the passenger. The notification device 150 may include visual notification means or audible notification means included in the vehicle 100. According to another embodiment, the notification device 150 may further include tactile means or the like in addition to the notification means.

For example, the visual notification means may include a display, a warning light, an internal lamp, and the like. The audible notification means may include a speaker, a buzzer, a notification bell, and the like.

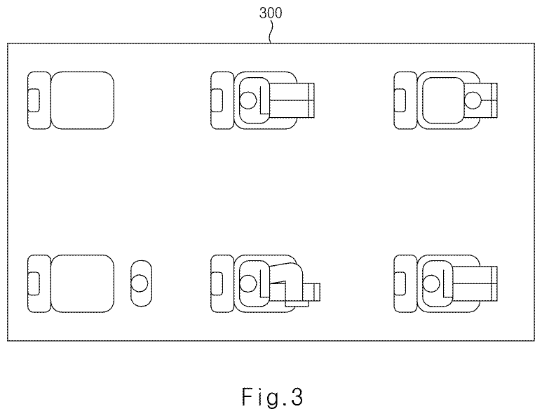

FIG. 3 is a first image according to an embodiment of the present disclosure.

FIG. 3 is for illustrating a method for generating, by the processor 130, the seating information of the passengers based on a first image 300.

FIG. 3 shows the first image 300 that captures an interior of the vehicle 100 in the direction perpendicular to the ground.

The first image may include the image corresponding to the plurality of seats on which the passengers may be seated and to the passengers.

The processor 130 may extract the positions of the seats in the vehicle 100 based on the image of the plurality of seats included in the first image. The processor 130 may store the seat information corresponding to the extracted positions of the seats in the memory 140.

According to an embodiment, the processor 130 may call the seat information stored in advance in the memory 140.

In addition, the processor 130 may extract the positions of the passengers in the vehicle 100 based on the image of the plurality of passengers included in the first image. The processor 130 may store the extracted positions of the passengers as the position information.

The processor 130 may generate the seating information based on whether the position information and the seat information match, and transmit the seating notification signal to the passenger. The seating notification signal transmitted to the passenger may contain information about the seat number.

As an example, when there is a passenger whose position information does not match the seat information, the processor 130 may determine that the passenger is not seated. In this regard, the processor 130 may transmit the seating notification signal to the passenger without generating the seating information. In addition, the processor 130 may not generate the departure possible signal or the travel possible signal when at least one of all of the passengers is not seated.

The processor 130 may classify the passengers by dividing a plurality of images included in the first image for each region corresponding to each passenger.

Having the position information that matches the seat information may mean a case in which the position of the seat and the position of the passenger overlap. As an example, a position of a passenger at a left lower end among the passengers in FIG. 3 does not overlap the seat, so that the passenger may be the passenger who does not have the position information that matches the seat information.

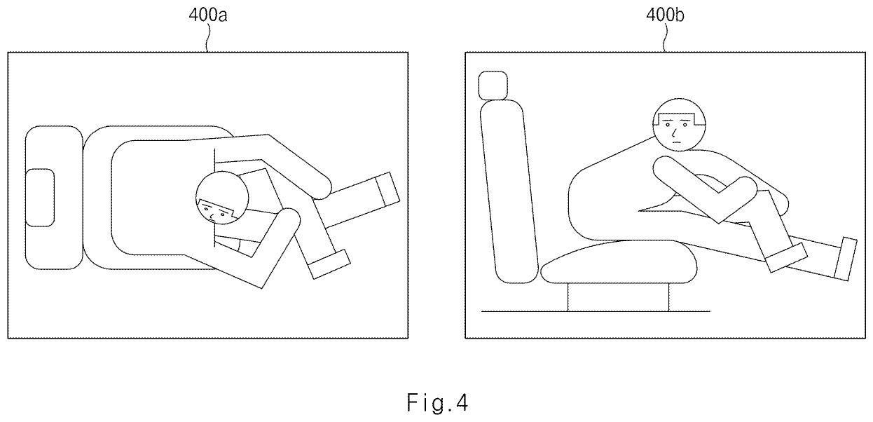

FIG. 4 exemplarily shows a first image 400a and a second image 400b according to another embodiment of the present disclosure.

FIG. 4 is for illustrating a method for generating, by the processor 130, the posture information of the passengers.

In addition, through FIG. 4, a method for assigning, by the processor 130, the degrees of risk corresponding to the seating postures of the passengers, and a method for making the first image 400a or the second image 400b to correspond to the posture information or the degree of risk and storing the image may be illustrated.

Even when the passengers are seated on the seats, when the posture of each passenger is not safe, there is a risk that the accident may occur when the vehicle 100 departs. Therefore, the processor 130 may identify the seating posture of the passenger and prevent the accident from occurring by generating the posture information of the passengers based on at least one of the first image 400a or the second image 400b.

In the first image 400a, a case in which the position information of the passenger matches the seat information, but the seating posture is not safe is illustrated as an example.

When the seating information of the passenger is generated, the processor 130 may match the passengers contained in the first image 400a and the second image 400b to each other.

In addition, the processor 130 may extract the posture information of each passenger based on at least one of the first image 400a or the second image 400b.

The processor 130 may identify the seating postures of the passengers based on the extracted posture information. The posture information may include the information about the gaze of the passenger and the seating posture of the passenger.

The processor 130 may extract an image corresponding to the body part of the passenger from the first image 400a or the second image 400b. The body part of the passenger may be, for example, a face, a waist, an arm, or the leg.

The processor 130 may extract the relative distance between the body parts, the relative angle between the body parts, and the like from the first image 400a or the second image 400b.

In addition, the processor 130 may extract distances between the seat and the body parts of the passenger and angles between the seat and the body parts from the first image 400a or the second image 400b.

The processor 130 may extract the posture information about the seating posture of the passenger based on the distance, the relative angle, and the like between the body parts of the passenger. As an example, the processor 130 may distinguish the body parts of the passenger from the first image 400a or the second image 400b, and may generate the posture information by extracting positions of the distinguished body parts from an arbitrary point in the first image 400a or the second image 400b or by extracting shapes of the body parts.

The posture information may include, for example, information about angles of the waist and the leg of the passenger, whether the legs are crossed, a rotation angle of a neck, and the like.

In addition, the processor 130 may detect a center of gravity from the image of the passenger, and the posture information may include information about the center of gravity.

The posture information may include information about the gaze direction of the passenger and a shape of the posture the passenger is taking. As an example, the passenger in FIG. 4 may turn a head thereof to the rear, cross legs thereof, and bent a waist thereof forward. A center of gravity of the passenger in FIG. 4 may be biased in the traveling direction of the vehicle 100.

The processor 130 may extract information about the body parts of the passenger contained in the second image 400b, respectively.

As an example, the processor 130 may distinguish a face, a waist, an arm, or the leg of the passenger contained in the first image 400a or the second image 400b from each other, and generate the information about the body parts, respectively.

In addition, the processor 130 may extract a distance the waist of the passenger is away from the backrest of the seat, an angle the waist of the passenger makes with the ground, the rotation angle of the neck of the passenger, and the like from the first image 400a or the second image 400b.

For example, when eyes and a nose of the passenger are identified from an image corresponding to the face of the passenger, the processor 130 may determine that the neck of the passenger is rotated in a direction opposite to the traveling direction of the vehicle.

In addition, when a sole of a foot is seen in the first image 400a or the second image 400b or both of the legs of the passenger are identified from the second image 400b, the processor 130 may determine that the legs of the passenger are crossed or that one leg is raised.

When the waist of the passenger is away from the backrest of the seat by a distance equal to or greater than a certain distance, when the neck of the passenger is rotated in the direction opposite to the traveling direction of the vehicle 100, or when the legs of the passenger are crossed, the passenger may lose the center of gravity thereof or may be injured when the vehicle 100 departs. Accordingly, the processor 130 may identify the seating posture of the passenger based on the posture information and generate the departure possible signal.

The processor 130 may assign the degree of risk in response to at least one of the gaze of the passenger or the seating posture of the passenger contained in the posture information. The degree of risk may be determined based on a probability that the passenger may be injured or a severity of the injury that occurs when the vehicle 100 departs while each posture is maintained corresponding to the posture information.

As an example, when the waist of the passenger is bent forward, there may be a high probability that the passenger will be injured in the head or the neck when the vehicle 100 departs, and the processor 130 may determine that a degree of risk for the posture in which the waist is bent is high. On the other hand, when only the head of the passenger is turned to the rear with the waist of the passenger attached to the backrest, even when the vehicle 100 departs, the probability of injury to the head or the neck of the passenger may be low. Therefore, the processor 130 may determine that a degree of risk for the posture of turning only the head is low.

The processor 130 may assign the different degrees of risk based on the postures of the body parts of the passenger.

The processor 130 may transmit the posture notification signal to the passenger when the seating posture of the passenger is not safe on the basis of the posture information of the passenger. The posture notification signal may be spread through the notification device 150 included in the vehicle 100.

According to one embodiment, the processor 130 may transmit the posture notification signal to a passenger taking a posture with a degree of risk equal to or higher than a certain degree.

The processor 130 may make the image of the passenger contained in the first image 400a and the posture information generated based on the second image 400b to correspond to the first image 400a or the second image 400b, and may store the corresponded information in the memory 140.

The processor 130 may compare the stored images 400a and 400b with the newly collected images. In this connection, the processor 130 may infer the posture of the passenger before generating the separate posture information based on the posture information corresponding to the stored images 400a and 400b with the high similarity to the newly collected image. According to an embodiment, the collection process of the second image may be omitted.

In addition, the processor 130 may make the degree of risk assigned based on the posture information of the passenger contained in the first image 400a or the second image 400b to correspond to the first image 400a or the second image 400b, and store the corresponded information in the memory 140.

The processor 130 may compare the stored images 400a and 400b with the newly collected image. In this regard, the processor 130 may infer the degree of risk of the posture information contained in the newly collected image based on the degree of risk corresponding to the stored images 400a and 400b with the high similarity to the newly collected image.

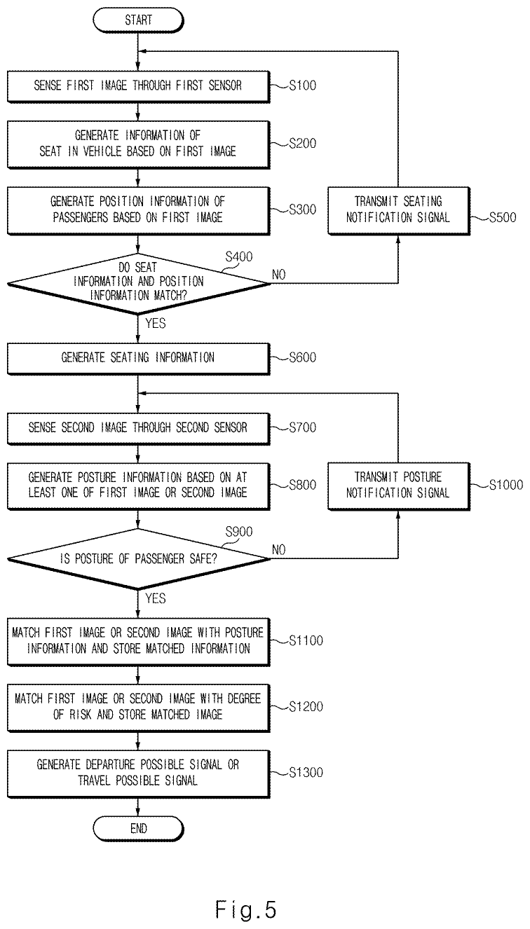

FIG. 5 is for illustrating an operating method of a vehicle that identifies passenger seating according to an embodiment of the present disclosure.

Referring to FIG. 5, the vehicle 100 may sense the first image through the first sensor 110 (S100).

The optical axis of the camera included in the first sensor 110 may be positioned perpendicular to the ground. Accordingly, the first image collected by the first sensor 110 may be the image collected in the direction perpendicular to the ground.

The processor 130 may generate the information of the seat in the vehicle 100 based on the first image (S200). The information of the seat in the vehicle 100 may include the information about the positions of the seats.

According to an embodiment, the generation of the information of the seat in the vehicle 100 may be performed during an initial sensing operation. The seat information generated through the initial sensing operation may be stored in the memory 140, and the processor 130 may call the stored seat information starting from a subsequent sensing operation. In other words, when the previously generated seat information is stored, the process of generating the seat information may be omitted.

The processor 130 may generate the position information of the passengers based on the first image (S300). The position information of the passengers may be the information corresponding to the positions of the passengers boarded the vehicle 100.

The processor 130 may determine whether the seat information and the position information match (S400). When the seat information and the position information do not match, the vehicle 100 may determine that the passenger is not seated (a NO path in operation S400).

The processor 130 may transmit the seating notification signal for the passenger when the passenger is not seated (S500).

The seating notification signal may be spread through the notification device 150 included in the vehicle 100. After spreading the seating notification signal, the vehicle 100 may sense the first image of the passenger again.

When the seat information and the position information of the passenger match (a YES path in S400), the processor 130 may generate the seating information of the passenger (S600).

The vehicle 100 may sense the second image through the second sensor 120 (S700). The optical axis of the camera included in the second sensor 120 may be positioned horizontal to the ground. Accordingly, the second image collected by the second sensor 120 may be the image collected in the direction horizontal to the ground. The second image may be an image collected in a direction horizontal to the ground as much as possible to include the passenger's face.

The processor 130 may generate the posture information based on at least one of the first image or the second image for the passenger for which the seating information is generated (S800).

The posture information may include the information about the gaze and the seating posture of the passenger, and may include, for example, the information about the angles of the waist and the leg of the passenger, whether the legs are crossed, the rotation angle of the neck, and the like.

The processor 130 may identify the seating posture of the passenger based on the posture information, and determine whether the posture of the passenger is safe based on the posture information (S900).

The safe posture of the passenger may mean a posture that is less likely to cause the passenger to lose the center of gravity or receive an unexpected shock when an external force is applied to the passenger by the departure of the vehicle 100. As an example, the safe posture may be a posture in which the passenger attaches the back thereof to the backrest of the seat of the vehicle 100, the gaze of the passenger is directed to the front, and the legs of the passenger are not crossed or raised.

The processor 130 may assign the degree of risk corresponding to at least one of the gaze of the passenger or the seating posture of the passenger to determine whether the posture of the passenger is safe.

The degree of risk may be determined based on the probability that the passenger may be injured or the severity of the injury that occurs when the vehicle 100 departs while each posture is maintained corresponding to the posture information.

When the seating posture of the passenger is not safe (a NO path in S900), the processor 130 may transmit the posture notification signal to the passenger (S1000). The posture notification signal may be spread through the notification device 150 included in the vehicle 100. The posture notification signal may contain the content instructing the passenger to change the posture and the guide information about the safe posture. According to an embodiment, the posture notification signal may contain information about a seat number of the passenger taking the unsafe posture.

According to one embodiment, the processor 130 may transmit the posture notification signal to the passenger taking the posture with the degree of risk equal to or higher than the certain degree.

The posture notification signal may be spread through the notification device 150 included in the vehicle 100. After spreading the posture notification signal, the vehicle 100 may sense the second image of the passenger again.

When it is determined that the posture of the passenger is safe (a YES path in S900), the processor 130 may match the collected first image or second image with the posture information and store the matched information (S1100).

The processor 130 may learn the posture information corresponding to the first image or the second image based on the information stored through operation S1100.

According to an embodiment, the processor 130 may omit the separate posture information extraction process by matching the corresponding posture information to the first image or the second image and storing the matched information.

The processor 130 may infer the posture information corresponding to the newly sensed image by comparing the newly sensed image with the previously stored images.

The processor 130 may match the collected first image or second image with the degree of risk and store the matched image (S1200). The processor 130 may rapidly infer the degree of risk from the newly collected image by matching the first image or the second image with the degree of risk and storing the image.

The operation of matching the first image or the second image with posture information and storing the matched information and the operation of matching the first image or the second image with the degree of risk and storing the matched image may be omitted according to an embodiment.

When it is determined that the posture of the passenger is safe, the processor 130 may generate the departure possible signal or the travel possible signal (S1300). When the seating information of all of the passengers boarded the vehicle 100 are generated and the postures of all of the passengers are determined to be safe, the processor 130 may generate the departure possible signal or the travel possible signal.

When the departure possible signal or the travel possible signal is generated, the vehicle 100 may activate the travel state from the stopped state and start traveling.

In addition, when being in the stopped state, the vehicle 100 may sense the first image and the second image, and generate the seating information and the posture information of the passenger. Whether the vehicle 100 is in the stopped state may be determined through the processor 130. For example, the stopped state may be determined based on the speed of the vehicle 100, the gear state, the brake operation state, and the like.

According to another embodiment, the vehicle 100 may sense the first image or the second image when being in the travel state, and the vehicle 100 may determine whether to continue traveling based on the seating information or the posture information of the passengers during the travel.

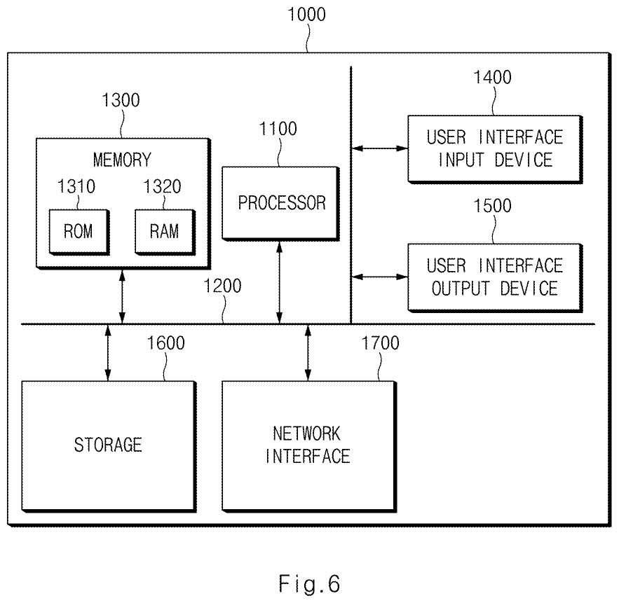

FIG. 6 is a block diagram illustrating a computing system that identifies passenger seating according to an embodiment of the present disclosure.

Referring to FIG. 6, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The present disclosure provides the vehicle that generates the seating information and the posture information of the passenger.

In addition, the present disclosure is able to provide the vehicle that transmits the seating notification signal or the posture notification signal to the passenger based on the seating information or the posture information.

The present disclosure has an advantage of ensuring the safety of the passenger by allowing the vehicle to determine whether the vehicle is able to depart or travel based on the seating information and the posture information.

In addition, various effects directly or indirectly identified through this document may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle comprising:
a first sensor for sensing a first image;
a second sensor for sensing a second image; and
a processor configured to:
generate seating information of a passenger based on the first image; and
generate posture information of the passenger with the generated seating information based on at least one of the first image or the second image.

2. The vehicle of claim 1, wherein the processor is further configured to:
generate information of a seat in the vehicle and position information of the passenger based on the first image; and
generate the seating information when the seat information matches the position information of the passenger.

3. The vehicle of claim 2, wherein the processor is further configured to transmit a seating notification signal to the passenger when the position information of the passenger does not match the seat information.

4. The vehicle of claim 1, wherein the first image is an image captured in a direction perpendicular to a ground.

5. The vehicle of claim 1, wherein the posture information comprises information about at least one of a gaze of the passenger or a seating posture of the passenger.

6. The vehicle of claim 5, wherein the processor is further configured to:
assign a degree of risk corresponding to at least one of the gaze of the passenger or the seating posture of the passenger; and
transmit a posture notification signal to the passenger based on the degree of risk.

7. The vehicle of claim 6, wherein the processor is further configured to match the first image or the second image with the posture information and store the matched information.

8. The vehicle of claim 6, wherein the processor is further configured to match and store the first image or the second image with the degree of risk, or match and store the posture information with the degree of risk.

9. The vehicle of claim 1, wherein the second image is an image captured in a direction horizontal to a ground, so that the passenger's face is included.

10. The vehicle of claim 1, wherein the processor is further configured to match a passenger contained in the first image with a passenger contained in the second image.

11. The vehicle of claim 1, wherein the processor is further configured to generate a departure possible signal or a travel possible signal when seating information of all passengers in the vehicle are generated based on the seating information and the posture information, and postures of all of the passengers are safe.

12. The vehicle of claim 1, wherein the processor is further configured to sense the first image or the second image when the vehicle is stopped.

13. The vehicle of claim 1, further comprising:
a notification device for spreading a posture notification signal or a seating notification signal.

14. An operating method of a vehicle, the method comprising:
sensing a first image through a first sensor;
generating, by a processor, seating information of a passenger based on the first image;
sensing a second image through a second sensor; and
generating, by the processor, posture information of the passenger with the generated seating information based on at least one of the first image or the second image.

15. The method of claim 14, further comprising:
generating, by the processor, information of a seat in the vehicle based on the first image; and
generating, by the processor, position information of the passenger based on the first image, wherein the processor is further configured to generate the seating information when the seat information matches the position information of the passenger.

16. The method of claim 15, further comprising:
transmitting, by the processor, a seating notification signal to the passenger when the position information of the passenger does not match the seat information.

17. The method of claim 14, further comprising:
determining, by the processor, whether a posture of the passenger is safe based on the posture information; and
transmitting, by the processor, a posture notification signal to the passenger when the posture of the passenger is not safe.

18. The method of claim 17, wherein the determining of whether the posture of the passenger is safe comprises:
assigning, by the processor, a degree of risk corresponding to at least one of a gaze of the passenger or a seating posture of the passenger contained in the posture information, and determining whether the posture of the passenger is safe based on the degree of risk.

19. The method of claim 17, further comprising:
matching, by the processor, the first image or the second image with the posture information and storing the matched information; and
matching and storing, by the processor, the first image or the second image with the degree of risk, or the posture information with the degree of risk.

20. The method of claim 14, further comprising:
generating, by the processor, a departure possible signal or a travel possible signal when seating information of all passengers in the vehicle are generated based on the seating information and the posture information, and postures of all of the passengers are safe.
